(19) United States
(12) Patent Application Publication
(10) Pub. No.: US 2005/0064937 A1
(43) Pub. Date: Mar. 24, 2005

(54) A game whereby the players create a portfolio of fantasy shares that are held and traded by game players in an organized electronic market

(76) Inventor: Glenn Ballman, Nevis (VG)

Correspondence Address: JEFFREY FURR, 253 N. MAIN STREET, JOHNSTOWN, OH, 43031, US

(21) Appl. No.: 10/605,269

(22) Filed: Sep. 18, 2003

(51) Int. Cl. G06F 17/00; G06F 19/00

(52) U.S. Cl. 463/40

(57) ABSTRACT

The current invention is a Sports Fantasy Game based on the internet where each Sports Figure is broken into fantasy shares and then offered and traded like securities in a continuous auction and call market auction format. Players compete for prizes by assembling the largest portfolio of shares and collecting the most dividends or payouts (dividends) based on shares they own when the Sports Figure gets points or completes specific tasks in the actual game.

### BACKGROUND OF INVENTION

1. Field of the Invention

The present invention relates to a game and, more particularly, to a game where game players create a portfolio of fantasy shares that are held and traded by game players in an organized electronic market.

2. Description of Prior Art

Throughout the United States and the world there is a great interest in sports and sports figures. There are a large number of fantasy game leagues where gamers own their own fantasy sports teams and sports players and compete with other garners or computers where the games are decided based on the current and past statistics of individual players who the gamer has on his or her team. These players are often assigned to a team based on a draft system between the players.

Many of these players use players who are currently playing while others use historic players like Babe Ruth or Johnny Unitas and others use a mixture depending on the garners playing. Even with these fantasy leagues, there is still a large interest in the ability to feel like the garners own a team of players and predict how they think a player is going to do in the future.

The Internet comprises a vast number of computers and computer networks that are interconnected through communication links. One use of the Internet is to play fantasy sports games with other game players across the country and across the world.

A market is defined as the means through which buyers and sellers are brought together to aid in the transfer of goods/services. There is no need to have a physical location or ownership of the goods and services it helps sell and it can deal in a variety of goods and services. When dealing with securities markets there are Primary markets, which deal with new issues, and Secondary markets where outstanding (existing) securities are bought and sold.

When dealing with Securities exchanges and exchange based fantasy games there are: Auction vs. dealer markets. In a pure auction market, buyers and sellers are matched by a broker at a central location. An auction market is a price driven market. In a dealer market, dealers provide liquidity by buying and selling shares. Dealers may compete against other dealers.

Call vs. continuous markets. Call markets trade individual securities at specified times to gather all orders and determine a single price to satisfy the most orders. These prices are used for opening prices on NYSE if orders build up overnight or after trading is suspended. Continuous markets trade any time the market is open.

There are certain major types of orders or game moves, such as: Market orders are buy or sell at the best current price and provide immediate liquidity.

Limit orders are orders that specify the buy or sell price and have time specifications which may vary: Instantaneous—“fill or kill”, part of a day, a full day, several days, a week, a month, or good until canceled (GTC)Short sales are the sell of overpriced securities that are not owned and are then purchased back later at a lower price. The investor borrows the security from another investor (through a broker). It can only be made on an up-tick trade, must pay any dividends to lender and margin requirements apply.

Special Orders are sells such as: Stop loss which is a conditional order to sell a security if it drops to a given price but it does not guarantee price received upon sale and market disruptions can cancel such orders; and Stop buy orders in which an Investor who sold short may want to limit loss if a security increases in price.

Margin Transactions which are on any type order, wherein instead of paying 100% cash, an investor can borrow a portion of the transaction, using the security as collateral.

Changes in a security price affect investor“s equity

There exists a need to provide internet game players and other gamers a game or simulation that allows them to own and trade shares in players and/or a team of players in a market. There is still need for improvement in the art.

### SUMMARY OF INVENTION

The current invention is a Sports Fantasy Game based on the internet where each Sports Figure is broken into fantasy shares and then offered and traded like securities in a continuous auction and call market auction format.

The invention entails a game whereby the game players create or are given a portfolio of fantasy shares that are held and traded by game players. These game players trade the shares between themselves in an organized electronic market. Further, the players receive fantasy dollars which is the artificial currency held in the market. Game players get more currency (or dividends) deposited into their accounts every time the sports player gets a point or achieves a measured result in a game (a sack, a rush return, hockey assist, basketball rebound etc. to name just a few) The amount of fantasy dollars each game player receives is calculated as a “dividend” on the number of shares held. So a game player that holds 1000 shares of XYZ sports player would receive 1 cent for every share held when the player scores a point. The value of the cash dividends changes for every position and sport.

Players compete for prizes by assembling the largest portfolio of shares and collecting the most dividends or payouts (dividends) based on shares they own when the Sports Figure gets points or completes specific tasks in the actual game. Example A player owns 1,000 shares of wide receiver Bill. Bill scores a touchdown, that player get 6 cents per share owned as a dividend.

The game may also be played with real dollars as with a process of dividending out cash based on the points scored by the sports player.

One objective of the current invention is to provide a fantasy game where game players buy, sell, trade and own fantasy shares in sports figures.

Another objective is for a gamer“s shares to be rewarded based on how well the sports figure does.

Other objectives and advantages of the present invention will become obvious to the reader and it is intended that these objectives and advantages are within the scope of the present invention.

To accomplish the above and related objectives, this invention may be embodied in the form illustrated in the accompanying drawings, attention being called to the fact, however, that the drawings are illustrative only, and that changes may be made in the specific construction illustrated.

Definitions: Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Dividends: Game players get more currency (or dividends) deposited into their accounts every time the traded entity (sports player, entertainer or other) gets a point or achieves a measured result in a contest or gameEmbedded client software programs: software programs that comprise part of a Web site and that get downloaded into, and executed by, the browser.

Fantasy Shares: These are fictional shares that a gamer may own in a sport figure or team.

Gamer: A person who owns fantasy shares.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Player: Same as a sports figure.

SEC: the Security and Exchange Commission.

Securities: For the purposes of this application, securities mean anything traded between parties such as Games and fantasy shares. Further, securities may mean rights to fantasy dividends or capital gains and/or rights to splits or receipt of other awards of fantasy shares.

Server host: a computer on the Internet that hands out Web pages through a Web server program.

Shares: For the purposes of this application, shares means a unit or units of ownership interest in a security as defined above.

Sports Figure: A person who is or was a professional or amateur athlete.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows how a user would access the Internet system;

FIG. 2 shows how securities are traded;

FIG. 3 shows how a Player earns Dividends;

FIG. 4 displays a Player Dividends screen;

FIG. 5 displays a marker order book of the current invention; and

FIG. 6 displays a sample portfolio screen of the current invention.

### DETAILED DESCRIPTION

The present invention creates a network based system for a Sports Fantasy Game based on the internet where each Sports Figure is broken into fantasy shares and then offered and traded like securities in a continuous auction and call market auction format.

In the preferred embodiment, players can compete for prizes by assembling the largest portfolio of shares and collecting the most dividends or payouts (dividends) based on shares they own when the Sports Figure gets points or completes specific tasks in the actual game. Example A player owns 1,000 shares of wide receiver Bill. Bill scores a touchdown, the player gets 6 cents per share owned as a dividend.

In the current invention there is the process of dividending out cash based on the points scored by the sports player.

The invention entails a game whereby the players create a portfolio of fantasy shares that are held and traded by game players. These game players trade the shares between themselves in an organized electronic market. Further, the players receive fantasy dollars which is the artificial currency held in the market. Game players get more currency deposited into their accounts every time the sports player gets a point or achieves a measured result in a game (a sack, a rush return, hockey assist, basketball rebound etc. to name just a few) The amount of fantasy dollars each game player receives is calculated as a “dividend” on the number of shares held. So a game player that holds 1000 shares of XYZ sports player would receive 1 cent for every share held when the player scores a point. The value of the cash dividends changes for every position and sport.

The game may also be played with real dollars as.

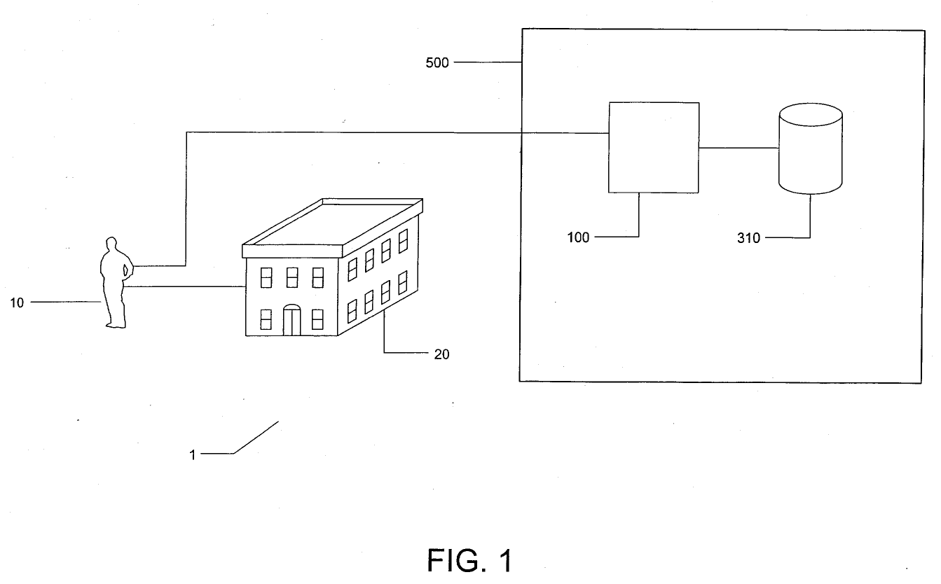

FIG. 1 illustrates a functional diagram of a computer network for World Wide Web 500 access to the System 1 which runs the game 2 from a plurality of Gamers 10 who access the system Web Site 100 or the Gamers 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon.

The Gamers 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Gamers 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Gamers 10 connect to the System Web Site 100. In the preferred embodiment the system has numerous web pages. The information in the web pages are in HTML format via the HyperText Transport Protocol (http) and on Server System 310. The Gamer System 110 includes software to allow viewing of web pages, commonly referred to as a Web Browser, such as Communicator available from Netscape Communications Corp. or Internet Explorer available from Microsoft Corp. The user system is capable of accessing web pages located on Server System 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 allows for secure input, data transfer and storage of a wide array of information. The system 1 allows and handles the direct transfer of security rights for the gamers 10. The input, data exchange and storage of the data is achieved by electronic data transmission, thus eliminating the need for paper logs. In a first embodiment of the invention, as further discussed below, means for processing data is provided which includes computer software installed at various locations within the data processing system. In a second embodiment of the invention, the data processing system has means for processing data which is installed on a web server computer; therefore, there is but one necessary installation of the means for processing data, and users log on to a website and conduct functions within the data processing system through the web server. The first embodiment can also be referred to as a Windows. TM. version, and the second embodiment can be referred to as a web browser version. The functionality of both embodiments is essentially the same; however, the second embodiment or the web browser version may incorporate some additional enhancements, as further discussed below. The data processing system in both embodiments utilizes a secure environment to transmit all data through encryption/decryption. The data processing system further provides for an audit trail of modifications made to the recorded data. The data processing system 1 for both embodiments includes computer processing means for processing data, storage means for storing data on a storage medium, and communication means for transferring data in a secure environment.

For the first embodiment on the Windows.TM. version, the data is entered on remote work stations and stored in local databases until the user performs a data transmission function which electronically transfers the data to a central database. The central database acts as a central repository enabling multiple off-site users to view and/or modify data, and generate reports or output. For the second embodiment or the web browser version, it can be conceptually broken down into two main components or groupings that allows the data processing system to achieve its functionality. They are as follows: (1) a main database that acts as the central repository for data entered into the system and (2) a means for processing data or computer software means in the form of coded computer instructions.

For the web browser version, it is unnecessary to have the different installations of the computer software because the web server computer has the entire means for processing loaded thereon. The user in the web browser version logs on to the website and then performs desired functions based upon functions made available to the type of user. There are two ways in which data is entered through the browser version: (1) through a website and transmitted via a LAN or the worldwide web to the web server. The web server then forwards the data to the database; or (2) through a data feed from a separate third party electronic online trading system and transmitted via a LAN or the worldwide web to the web server or an FTP server. The web server or FTP server then forwards the data to the main database. Transmission of data in the second embodiment via the worldwide web or LAN is also secure utilizing data encryption/decryption provided by SSL. Other than consolidation of the means for processing data at the web server computer, and the manner in which data is entered and retrieved through a website, the first and second embodiments have the same functionality, except for those additional features discussed below with respect to the second embodiment.

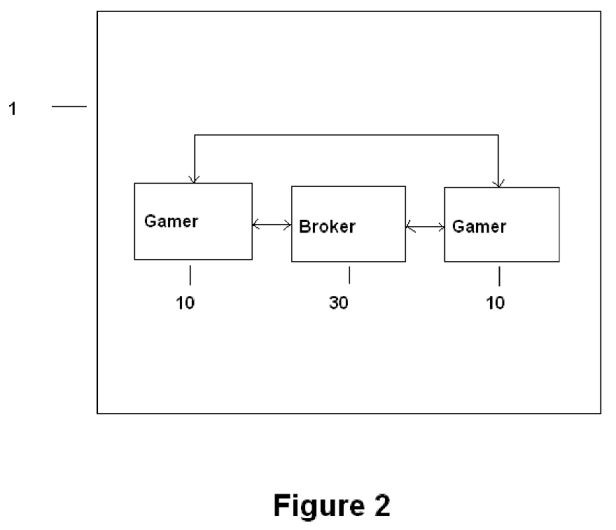

As shown in FIG. 2, currently a gamer 10 desires to buy or sell securities. This can be done by directly or by a broker 30.

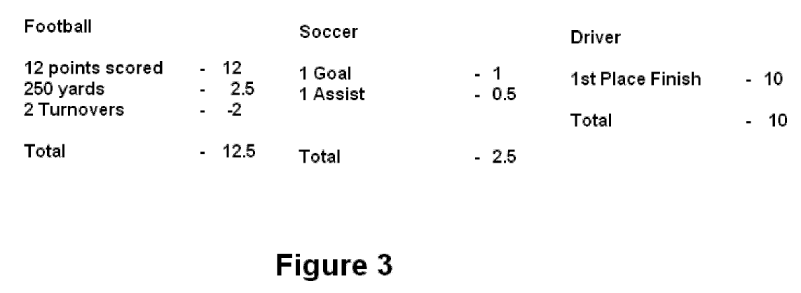

As shown in FIG. 3, a gamer 10 can earn dividends based on a player“s performance history or overtime. A football player earns dividends for points scored, in the example a quarterback scores 12 points for two touchdowns, 1 point per each 100 yards of gain and a negative 2 points for two interceptions thrown for a total of 12.5. A soccer player earns 2 point for each goal scored and 0.5 point for an assist for a total of 2.5 points. A racecar driver earns 10 point for coming in first in the race for a total of 10 points. The dividend earned depend on the sports that is being played by the player. A gamer 10 can have a portfolio made up of a single real team, a fantasy team or a multiple sports team and compete with other players to see who will have the largest portfolio.

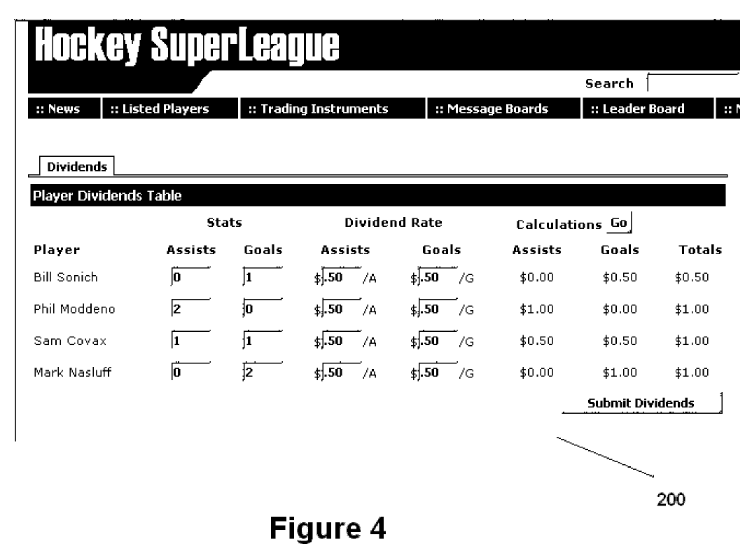

As shown in FIG. 4, the invention also entails Player Dividends Table 200. This screen displays the Sports Figure“s dividends for Hockey Players. The fields are: Players, who are the sport figures who are on the system; Stats, which are the sports figures statistics which in this case are Assists and Goals; Dividend Rates, which are the dividends paid out for the assists and goals; a Calculations button, which causes the system 1 to calculate the current dividend, and a total which shows the total value of the Assists, Goals and sum of the Assist and Goals. This screen can be modified for other sports such as baseball, which statistics such as RBIs (Runs Batted In), Runs, errors and ERA (earned runs allowed) or football with points scored, yards, sacks, tackles and turnovers.

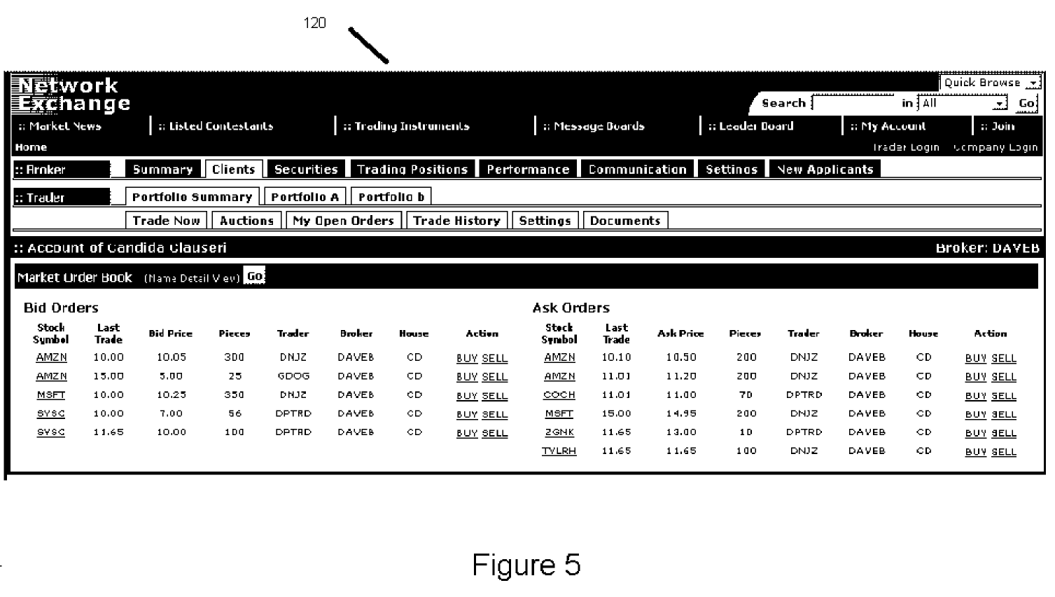

FIG. 5 shows a tentative screen view of a sample of the current invention's Market Order Book 120 which is used to track a gamers 10 buying and selling of shares. The Market Order Book and an Securities Exchange System are described in more detail in patent application Ser. Nos. 10/604,766 and 10/604,762 which are incorporated by reference. The Book 120 in the preferred embodiment has the following fields.

On bid orders there are the following fields; Security symbol, which is the symbol that signifies the sports figure or team being traded. Last Trade is the last trading price. Bid Price is the bid that the bidder is offering. Pieces is the number of shares or pieces of the security wanted.

On ask orders there are the following fields; Security symbol, which is the symbol that signifies the sports figure or team being traded. Last Trade is the last trading price. Ask Price is the bid that the asker is wanting. Pieces is the number of shares or pieces of the security (the sports figure or team) wanted. Trader is the actual beneficial rights holder of the transaction, not the broker.

The order book will use colors for the auction order book price display. Red will be used for downward prices for day, while green will be used for upward prices for the day.

In the preferred embodiment, the order book has the actual rights holder, but it also have a place for the broker name/symbol to and the broker house/symbol to be attached. The name of the gamer 10, and the name of the broker 30, and the name of the broker house can be changed to 6 letter symbols for the reduction of space for example:

Action Shares Security Holder Agent Firm

Buy 100Babe FURR TEBR NODBR UNThis

is an order for 1000 Babe Ruth shares from Furr placed by his agent/broker Ted Brown, from the ga me based firm Odium Brown.

The system 1 will give gamers 10 the option to view the order book in “full name” or “symbols” mode. This is shown below:

Action Shares Security Holder Agent Fir m

Buy 1000 BabeJ EF FR EJY FURRTE RRY BROWNOd lum Brownln th

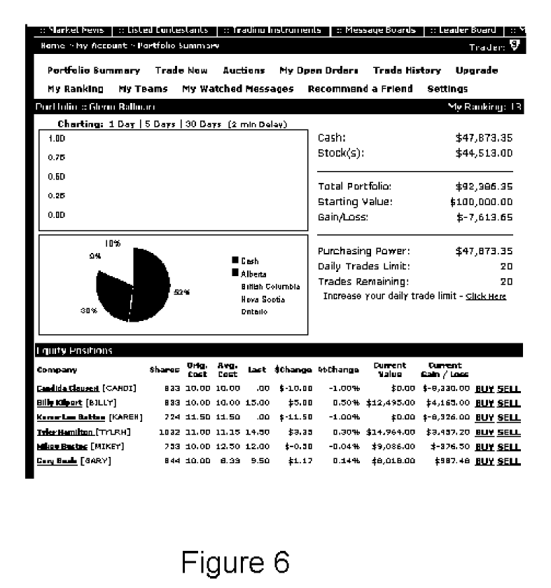

The system 1, the trader is actual beneficial rights holder of the securities being traded, not the broker. FIG. 6 shows the Portfolio Summary Screen of the current invention. It has been designed to displace as much information as possible to make it as useful as possible for the Gamer 10.

It has the portfolio owner being listed in the upper right hand corner and can have a ranking for comparison to other gamers. There is a charting display, which charts how well the portfolio is doing. This charting can be for 1, 5 or 30 days, or 1 year, 3 years or 5 years in the preferred embodiment. There is a pie chart that shows the percentages of each type of security represented in the portfolio. There is a display for the amount of cash and value of stocks and/or other types of securities that make up the portfolio as well as displaying the total portfolio value, starting portfolio value and the amount of gain or loss. It displays the purchasing power of the portfolio, the daily trades limit and amount of trades remaining.

The Portfolio Summary in the preferred embodiment will have the Equity Positions and Securities position held on the Portfolio displayed. This will include the sports figure or team name, the number of shares, the original cost of the shares, the average cost of the shares, the last quoted prices of the shares, the dollar change between the purchase price and quoted price, the percentage dollar change between the purchase price and the quoted price and the current value of the shares. This section will also have a buy/sell tab where a Gamer 10 can click to either place an order for more shares or offer shares for sell. This buy/sell tab will allow buyers and sellers of securities to deal directly with each other as the rights holders.

The System 1 will be written using programming languages, techniques and knowledge that is commonly known in the art.

Alternative Embodiment

The current invention can apply not to fantasy share, but can represent interests in real teams and players.

In an alternative embodiment, gamers 10 can play and trade with real money for the securities.

In another embodiment, the security interest can be in other people such as politicians or entertainers.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:
A securities system comprising:

1. A system that has a plurality of people represented by shares and traded like securities.

2. A system according to claim 1 in which said people are sports figures.

3. A system according to claim 1 in which said people are entertainment figures.

4. A system according to claim 1 in which said people are politicians.

5. A system according to claim 1 in which said system is a data processing system.

6. A system according to claim 5 in which said system is processed in a client server system.

7. A system according to claim 5 in which said system is connected to through the Internet.

8. A system according to claim 5 in which said system is connected to wireless devices.

9. A system according to claim 5, further comprising: (a) computer processor
means for processing data; (b) storage means for storing said data on a storage
medium; (c) communication means for transmitting data in a secure environment to and from various remote locations; and (d) computer software means for creating and displaying trade data concerning a particular trade in the form of a trade record.

10. A system, as claimed in claim 9 wherein said computer software means further comprises: means for inputting and storing system information on said storage means.

11. A system according to claim 2 in which said system is a data processing system.

12. A system according to claim 11 in which said system is processed in a client server system.

13. A system according to claim 11 in which said system is connected to through the Internet.

14. A system according to claim 11 in which said system is connected to wireless devices.

15. A system according to claim 11, further comprising:
(a) computer processor means for processing data; (b) storage means for storing said data on a storage
medium; (c) communication means for transmitting data in a secure environment to and from various remote locations; and (d) computer software means for creating and displaying trade data concerning a particular trade in the form of a trade record.

16. A system, as claimed in claim 15 wherein said computer software means further comprises: means for inputting and storing system information on said storage means.

17. A system according to claim 1 in which said system is set up as a game.

18. A system according to claim 17 in which said game awards prizes based on performance of said securities.

19. A system according to claim 1 in which dividends are awarded based on measurable performance of said people.
